(19) United States
(12) Patent Application Publication
(10) Pub. No.: US 2007/0065573 A1
(43) Pub. Date: Mar. 22, 2007

(54) Method for fabricating optical compensatory films

(75) Inventors: Kuang-Rong Lee, Ping Chen (TW); Mei-Ling Wang, Ping Chen (TW); Yi-Jen Lin, Ping Chen (TW); Yu-Hwey Chuang, Ping Chen (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Ping Chen (TW)

(21) Appl. No.: 11/401,079

(22) Filed: Apr. 10, 2006

(30) Foreign Application Priority Data
Sep. 19, 2005 (TW) 094132347

(51) Int. Cl. B05D 5/06; B05D 3/02; B05D 3/12; B05D 1/30; B05D 1/18

(52) U.S. Cl. 427/162; 427/372.2; 427/355; 427/430.1; 427/240; 427/420

(57) ABSTRACT

A method for fabricating optical compensation films includes providing PAR polyarylate; dissolving the PAR polyarylate in an solvent to obtain a polyarylate solution; applying the polyarylate solution on a substrate; and substantially removing the solvent from the polyarylate solution under a predetermined temperature to form an optical compensation film having a thickness of 1 μm to 20 μm. The optical compensation film is optically anisotropic and suitable for use in photoelectric flat displays.

### BACKGROUND OF THE INVENTION

1. Field of Invention

The present invention relates to a method for fabricating an optical element, more particularly, the present invention relates to a method for fabricating an optical compensation film for use in photoelectric flat displays.

2. Description of Related Art

Liquid crystal displays, due to many advantages compared to those of the traditional CRTs, are replacing the popularity of traditional CRTs as the main stream on the market. In addition to the liquid crystal cells, there are still many thin films required to adjust the optical properties of the LCD.

For instance, an LCD needs a pair of thin birefringence films made from special polymers to adjust the “A” value and the “C” value, which are defined as follows:
A=(nx−ny)d (I)
C={[(nx+ny)/2]−nz}d (II)

wherein: nx [symbol] ny [symbol] nz are refraction index at x [symbol] y [symbol] z direction respectively and d is thickness A discoid liquid crystal disclosed in U.S. Pat. No. 5,583,679 and a polyimide with planar benzene ring on the skeleton (U.S. Pat. Nos. 5,395,918, 5,480,964 and 5,580,950) all are useful as materials for negative C plates. In prior arts, these discoid liquid crystal and polyimide with planar benzene ring on the skeleton have undesirable large birefringence in the direction of the thickness and absorb visible light. They need applying on the transparent protecting layer carefully.

Additionally, coating process is extremely costly. One method is that an optical compensation film is manufactured using 8-20% polyarylate (PAR) in dichloromethane by way of the solvent casting to achieve a thickness of 80 μm to 200 μm. Then the film is stretched uniaxially 15-30% to be an optical compensation film, such as U.S. Pat. No. 5,189,538 [symbol] 5,138,474 and 5,285,303. Because the thickness of the film from the prior art is in the range of 80 μm to 200 μm, and the consequent A value of the film after mono-axial extension is relatively high (about 400 nm), in addition to the higher cost, the optical properties are also very sensitive to the thickness of the coating due to higher birefringence.

For the forgoing reasons, there is a need for a less thick and less costly optical compensation film with desirable optical properties.

### SUMMARY

It is therefore an objective of the present invention to provide a method for fabricating an optical compensation film. The process of the present invention is simpler and therefore dramatically reduces the cost which makes the products more competitive.

It is another objective of the present invention to provide a method for fabricating an optical compensation film. In spite of the thinner thickness, the optical properties of the optical compensation films fabricated by the present invention are still desirable.

In accordance with the foregoing and other objectives of the present invention, the present invention provides a method for fabricating an optical negative C value plate. The method includes first providing a polyarylate (PAR) and dissolving the polyarylate in an solvent to obtain a polyarylate solution. Then the polyarylate solution is directly applied on a substrate and the solvent is removed from the polyarylate solution under a predetermined temperature to form an optical compensation film having a thickness of from 1 μm to 20 μm, useful in photoelectric flat displays, such as liquid crystal displays, organic liquid crystal displays or polymeric liquid crystal displays as view angle compensation film.

In one preferred embodiment of the present invention, the suitable polyarylate may be polyacrylate. The ideal solvent may be haloalkanes, such as dichloromethane, dichloroethane, tetrachloroethane or chloroform; the aromatic solvent may be toluene; cycloketones may be cyclopentanone, cyclohexanone; ethers may be tetrahydrofuran (THF); ketones may be acetone, methylethylketone (MEK), 1-methylpyrrolidone (NMP), dimethylsulfoxide (DMSO) or dioxolane, or the combination thereof. The polyarylate solution may be applied on a substrate by any way of the bar coating, the reverse roller coating, the roll coating, the gravure coating, the dip coating, the spin coating, the slot-die coating, the extrusion coating and the curtain coating or the combination thereof.

The optical compensation films fabricated by the present invention are advantageous. On one hand, the thickness of the optical compensation films fabricated by the present invention is about 1 μm to 20 μm, much thinner than that of the film obtained in the prior art, which is in the range of 80 μm to 200 μm. On the other hand, the process of the present invention is simpler and therefore dramatically reduces the cost which makes the products more competitive. Furthermore, the optical properties of the optical compensation films fabricated by the present invention are still desirable.

These and other features, aspects, and advantages of the present invention will become better understood with reference to the following description, and the appended claims.

### BRIEF DESCRIPTION OF THE DRAWINGS

N/A

### DESCRIPTION OF THE PREFERRED EMBODIMENTS

The present invention relates to a method for fabricating an optical compensation film. The optical compensation film is highly optically anisotropic and suitable for use in photoelectric flat displays, such as liquid crystal displays, organic liquid crystal displays or polymeric liquid crystal displays as view angle compensation film. These and other features, aspects, and advantages of the present invention will become better understood with reference to the following description and appended claims.

The present invention intends to fabricate an optical plate of negative C value. First, a polyarylate (PAR) is provided. The polyarylate can be obtained by polymerizing appropriate polyarylate precursors, such as bisphenol A and dicarboxylic acid. Once the appropriate polyarylate precursors are selected, they can be transformed into polyarylates of molecular weight of 10,000 to 100,000, suitable as candidates of materials as optical compensation films.

Then the obtained polyarylates are dissolved in a suitable solvent to obtain a polyarylate solution. Preferably, the polyacrylate is contained in a range about 10 to 20% wt. The ideal solvent, to the knowledge of persons skilled in the art, may be haloalkanes, such as dichloromethane, dichloroethane, tetrachloroethane or chloroform; the aromatic solvent may be toluene; cycloketones may be cyclopentanone, cyclohexanone; ethers may be tetrahydrofuran (THF); ketones may be acetone, methylethylketone (MEK), 1-methylpyrrolidone (NMP), dimethylsulfoxide (DMSO) or dioxolane, or the combination thereof.

Moreover, the formulated polyarylate solution is applied on a substrate by any way of, for examples, the bar coating, the reverse roller coating, the roll coating, the gravure coating, the dip coating, the spin coating, the slot-die coating, the extrusion coating and the curtain coating. The polyarylate solution just applied on the substrate is called “wet film,” due to the presence of the solvent(s). The thickness of the wet film depends on the type of the polyacrylate, distribution of the molecular weight, the concentration of the polymer solution, and the intrinsic viscosity of the solvent(s). It is preferred that the thickness of the wet film is as thin as possible, ideally to be in the range of 30 μm to 200 μm, to facilitate the removal of the solvent therein.

Later, the solvent may be substantially, i.e. preferably lower than 1% solvent residue, removed from the polyarylate solution under a predetermined temperature, preferable at an elevated temperature between 40-180° C., to form an optical compensation film having a thickness of from about 1 μm to 20 μm. The film, in the absence of solvent, is called “dry film” in contrast to the “wet film.” During the is removal of the solvent, the temperature can be gradually elevated, preferably by an elevating temperature gradient such as combination of 40° C. for 20 min, 60° C. for 20 min, 80° C. for 20 min and 100° C. for 60 min, to substantially remove the solvent. The type of the polymer, the molecular weight distribution, the concentration of the polymer solution, and the boiling point of the solvent are all the factors in choosing an appropriate temperature. For example, a temperature range between 40-180° C. is ideal to remove cyclohexanone from the polyarylate solution.

Generally, the preferred substrate of the present invention may be glass, surface-treated PET or polyethylene. The substrate may usually include a layer made of triacetate cellulose (TAC), or the substrate is TAC intrinsically. Besides, the substrate may also include a layer of a optical compensation film made of materials such as polycarbonate (PC), TAC, and mCOC to adjust or to compensate the anisotropy, R0 value, of the obtained optical compensation film. Therefore, the optical compensation film optically compensates a LCD with the VA mode or the TN mode which has the higher refraction index along the direction of thickness than the planar direction.

In order to optimize the thickness of the obtained dry film, or to modify the refraction index along the horizontal direction, the optical plate of negative C value applied on the TAC can be processed by thermo-extension or by a mechanical force to stretch the optical compensation film. For example, the optical compensation film is duel-axially stretched by heating to the Tg (glass transition temperature) temperature, about 150° C., of the TAC glass and by extending force or horizontal mechanical force by Instron to obtain an optical compensation film of Rth+R0 value.

The said dry film may be further post-treated to improve a physicochemical property of the optical compensation film. The post-treatment may be base wash, acid wash, plasma, electric arc, corona (250 kW to 500 kW) or the combination thereof. Different post-treatments may accomplish different effects to meet different demands. For example, the contact angle may be improved.

Furthermore, other methods may also be employed to improve the optical properties of the film, such as laminating the substrate with an A-plate of uniaxial anisotropy or applying an A-plate of uniaxial anisotropy on the substrate, or changing the horizontal refraction index (as if having been duel-axially stretched) to obtain an optical compensation film of Rth+R0 value.

The optical compensation films fabricated by the present invention are advantageous. The thickness of the optical compensation films fabricated by the present invention is about 1 μm to 20 μm, much thinner than that of the film from the prior art. On the other hand, the process of the present invention is simpler and therefore obviously reduces the cost which makes the products more competitive. Furthermore, the optical properties of the optical compensation films fabricated by the present invention are still desirable.

The following are the examples of the present invention illustrating the method of the present invention.

### EXAMPLE

A solution weighted 13 g is formed with 13% PAR and 20% dioxolane at 50° C. The solvent used in the formation of the solution is 87 g and composed of 20% tetrahydrofuran (THF)/dioxolane solution. After polymers being sufficiently dissolved in the solvent and the total solution being filtered, the filtered solution is applied on a glass substrate by a scraping cutter to form a wet film having thickness of a range from 30 μm to 200 μm.

Then, heat the wet film under a temperature gradient which is rising from 40° C. to 180° C. to sufficiently remove the solvent.

For the obtained film, the haze and total transmittance are measured by NIPPON DENSHOKU Haze Meter NDH 2000 and the plane retardation is measured by the Oji Scientific Instruments KOBRA-21ADH. The results are as follows.

| | Test | | |
|---|---|---|---|
| | 1 | 2 | 3 |
| Thickness(μm) | 6.8 | 11.0 | 18.0 |
| HZ(haze) | 0.46 | 0.75 | 4.51 |
| TT(total transmittance) | 89.46 | 89.43 | 89.84 |
| R0(in-plane retardation) | 0.3 | 1.2 | 1.5 |
| Rth(out-plane retardation) | 127.3 | 218.1 | 311.6 |
| slow-axis deviation | −44.9 | −63.8 | 59.4 |

The above results show that the optical compensation films fabricated by the method of the present invention and have increased the VA view angle while the thickness of the optical compensation film is increased.

Although the present invention has been described in considerable detail with reference certain preferred embodiments thereof, other embodiments are possible. Therefore, their spirit and scope of the appended claims should no be limited to the description of the preferred embodiments contained herein.

What is claimed is:

1. A method for fabricating an optical compensation film, comprising:
providing a polyarylate;
dissolving the polyarylate in a solvent to obtain a polyarylate solution;
applying the polyarylate solution on a substrate; and
removing the solvent from the polyarylate solution under a predetermined temperature to form an optical compensation film having a thickness of a range from 1 μm to 20 μm.

2. The method for fabricating an optical compensation film as claimed in claim 1, wherein the polyarylate is selected from the group consisting of bisphenol A and dicarboxylic acid.

3. The method for fabricating an optical compensation film as claimed in claim 1, wherein the solvent is selected from the group consisting of haloalkanes, aromatics, cycloketones, ethers, ketones, 1-methylpyrrolidone (NMP), dimethylsulfoxide (DMSO), dioxolane and the mixture thereof.

4. The method for fabricating an optical compensation film as claimed in claim 1, wherein the polyarylate solution comprises the polyarylate of 10 to 20% wt.

5. The method for fabricating an optical compensation film as claimed in claim 1, wherein the polyarylate solution is applied on the substrate by one of a bar coating, a reverse roller coating, a roll coating, a gravure coating, a dip coating, a spin coating, a slot-die coating, a extrusion coating and a curtain coating.

6. The method for fabricating an optical compensation film as claimed in claim 1, wherein the substrate is selected from one of glass, PET and PE.

7. The method for fabricating an optical compensation film as claimed in claim 1, wherein the substrate further comprises a plane retardation film.

8. The method for fabricating an optical compensation film as claimed in claim 1, wherein removing the solvent is carried out under a temperature between 40° C. and 180° C.

9. The method for fabricating an optical compensation film as claimed in claim 8, wherein removing the solvent is carried out under a temperature gradient which is rising from 40° C. to 180° C.

10. The method for fabricating an optical compensation film as claimed in claim 1, wherein removing the solvent is carried out till the content of the solvent in the polyarylate solution is less than 1% wt.

11. The method for fabricating an optical compensation film as claimed in claim 1, wherein further comprising stretching the optical compensation film by thermo-extension or by a mechanical force.

12. The method for fabricating an optical compensation film as claimed in claim 1, wherein further comprising laminating the substrate with an A-plate of uniaxial anisotropy or applying an A-plate of uniaxial anisotropy on the substrate.

13. The method for fabricating an optical compensation film as claimed in claim 1, wherein further comprising post-treating the optical compensation film to improve a physicochemical property of the optical compensation film.

14. The method for fabricating an optical compensation film as claimed in claim 13, wherein the post-treatment of the optical compensation film is selected from any one of base wash, acid wash, plasma, electric arc, corona and the combination thereof.

15. The method for fabricating an optical compensation film as claimed in claim 13, wherein the physicochemical property is a contact angle.

16. A method for fabricating an optical compensation film, comprising:
providing a polyarylate;
dissolving the polyarylate in a solvent to obtain a polyarylate solution;
applying the polyarylate solution on a substrate; and
removing the solvent from the polyarylate solution under a predetermined temperature to form an optical compensation film having a thickness of 1 μm to 20 μm resulting on the substrate.

17. The method for fabricating an optical compensation film as claimed in claim 16, wherein the substrate is selected from one of glass, PET and PE.

18. The method for fabricating an optical compensation film as claimed in claim 1, wherein the substrate further comprises a layer of TAC.
